(19) United States
(12) Patent Application Publication
(10) Pub. No.: US 2003/0092453 A1
(43) Pub. Date: May 15, 2003

(54) Methods and apparatus for communicating information from a remote wireless device to a cordless telephone system

(76) Inventors: Kenneth Russell Mills, Fishers, IN (US); Thomas Charles Clifford, Indianapolis, IN (US); Wilhelm Ernst Riedl, Indianapolis, IN (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 10/007,242

(22) Filed: Nov. 10, 2001

(51) Int. Cl. H04Q 7/20

(52) U.S. Cl. 455/463; 455/3.05; 455/556

(57) ABSTRACT

A remote wireless intercom and other devices for communicating with a cordless telephone system are disclosed. The remote wireless intercom includes a transmitter, a receiver, a speaker, a microphone, a battery interface, and a housing which carries these components. A method of communicating between the remote wireless intercom and a cordless telephone device involves the steps of detecting an intercom voice communication request at the remote wireless intercom; wirelessly transmitting the intercom voice communication request from the remote wireless intercom to the a cordless telephone device; and engaging the remote wireless intercom in an intercom voice communication session with the cordless telephone device after transmitting the intercom voice communication request. Preferably, the cordless telephone device is a cordless base station and the intercom voice communication session takes place between the remote wireless intercom and a cordless telephone. A unique intercom alert is provided at the cordless telephone device when the intercom voice communication request is received.

### BACKGROUND OF THE INVENTION

1. Field of the Invention

The present invention relates generally to cordless telephone systems and other various devices, such as intercoms, computers, and televisions; and more particularly to devices that are configured to communicate information to cordless telephone systems.

2. Description of the Related Art

Conventional communication devices, such as cordless telephones, are limited because they are unable to receive and utilize information from other various devices, such as intercoms, sensors, televisions, video camera recorders (VCRs), radios, and computers.

To illustrate, FIG. 1 is a schematic block diagram of a cordless telephone system 100 of the prior art. Cordless telephone system 100 includes a cordless base station 102, which may be referred to as a cordless base unit, and a cordless handset 108, which may be referred to as a cordless telephone unit. Cordless telephone system 100 provides wireless telephone communications within a relatively small geographical area for an end-user. Cordless handset 108 typically includes a user interface which includes a speaker, a microphone, a display, and a keypad having conventional dual-tone multiple frequency (DTMF) keys for telephone number dialing. Cordless handset 108 may be one handset of a plurality of cordless handsets 104 utilized in connection with cordless base station 102. As shown in FIG. 1, the plurality of cordless handsets 104 include cordless handsets 108-112, designated as cordless handsets 1 through N.

Cordless base station 102 and cordless handset 108 communicate with each other via radio frequency (RF) signals 106. Cordless base station 102 has an interface for coupling to an alternating current (AC) power source 114, such as that commonly provided in a home residence or business. Cordless base station 102 has another interface for coupling to a land line 116, which couples cordless base station 102 to a public switched telephone network (PSTN) for land line telephone communication.

A plurality of other various devices 120 are also shown in FIG. 1. The plurality of devices 120 include devices 128-132, designated as devices 1 through M, which are incompatible with cordless telephone system 100. That is, the plurality of devices 120 and cordless telephone system 100 are not configured to interact or communicate information with each other. The plurality of devices 120 may include devices such as an intercom which is installed in a home residence or business, a computer such as a personal computer (PC) or laptop (with or without browser software for the Internet or World Wide Web), an AM/FM radio (including its related tape and CD player) and its associated wireless remote controller, a television and its associated wireless remote controller, a video camera recorder (VCR) and its associated wireless remote controller, and sensors such as temperature sensors, weather sensors, and motion detection sensors. A large body of information is now available using the computer in the creation of the Internet and World Wide Web (WWW).

Although the plurality of devices 120 are electrical in nature and may even have wireless communication capabilities, cordless telephone system 100 cannot communicate with them nor utilize any information from them. Having many different devices that are incompatible with each another is frustrating to end-users who must utilize the interface of each device separately for its specific purpose.

Accordingly, what are needed are methods and apparatus for communicating information from various devices to cordless telephone systems.

### SUMMARY OF THE INVENTION

A communication system of the present invention involves a cordless telephone system including at least one cordless base station and at least one cordless telephone unit for communicating with the at least one cordless base station. The at least one cordless telephone unit has a user interface, such as a visual display or a speaker, for conveying user information to an end-user of the cordless telephone unit. Advantageously, the cordless telephone system and a remote wireless device are configured for communicating with each other. The remote wireless device includes a controller which generates or obtains the user information, and a transmitter which transmits the user information to the cordless telephone system to be conveyed at the user interface of the cordless telephone unit.

The remote wireless device may be a remote wireless intercom which includes a speaker, a microphone, a receiver, a battery interface, and a housing which carries all of these components. Here, the user information involves voice signals, and the speaker, the microphone, the receiver, and the transmitter are used for engaging in an intercom voice communication session with the cordless telephone system.

A method of communicating between the remote wireless intercom and a cordless telephone device involves the acts of detecting an intercom voice communication request at the remote wireless intercom; transmitting the intercom voice communication request from the remote wireless intercom to a cordless telephone device; and engaging the remote wireless intercom in an intercom voice communication session with the cordless telephone device after transmitting the intercom voice communication request. The act of detecting the intercom voice communication request may involve detecting a switch actuation at the remote wireless intercom, or detecting a motion sensor signal at the remote wireless intercom. The intercom communication session may involve communication between the remote wireless device and the cordless base station directly, or between the remote wireless device and the cordless telephone unit through the cordless base station. A unique intercom alert is provided at the cordless telephone device when the intercom voice communication request is received.

Alternatively, the remote wireless device may have a communication interface configured for coupling to a computer. In this case, the computer has an application program residing in memory which is executable to generate the user information which is sent to the remote wireless device for transmission to the cordless telephone system. The application program may be any suitable application program, such as a scheduling notification program, an electronic mail program, or an audio delivery program. Finally, the remote wireless device may be coupled to and receive the user information from other various devices, such as a sensor which can be a temperature sensor, a weather sensor, or a motion detector sensor.

Advantageously, the remote wireless devices and the cordless telephone system are able to communicate with each other and provide useful information. Having many different devices that are compatible in accordance with the present invention ends the frustration of end-users who would otherwise have to utilize the interface of each device separately for each specific purpose.

### BRIEF DESCRIPTION OF THE DRAWINGS

FIG. 1 is a schematic block diagram of a cordless telephone system and various incompatible devices of the prior art;

FIG. 2 is a schematic block diagram of a cordless telephone system and various remote wireless devices of the present invention;

FIG. 3 is a schematic block diagram of a cordless telephone device (cordless base station or handset) and a remote wireless intercom;

FIG. 4 is a schematic block diagram of a computer and a remote wireless device;

FIG. 5 is a flowchart describing a method of sending information from the remote wireless intercom to the cordless telephone device of FIG. 3;

FIG. 6 is a flowchart describing a method of receiving information at the cordless telephone device from the remote wireless intercom of FIG. 2;

FIG. 7 is a flowchart describing a method of sending information to the cordless telephone system from the remote wireless device of FIG. 4; and

FIG. 8 is a flowchart describing a method of receiving information at the cordless telephone system from the remote wireless device of FIG. 4.

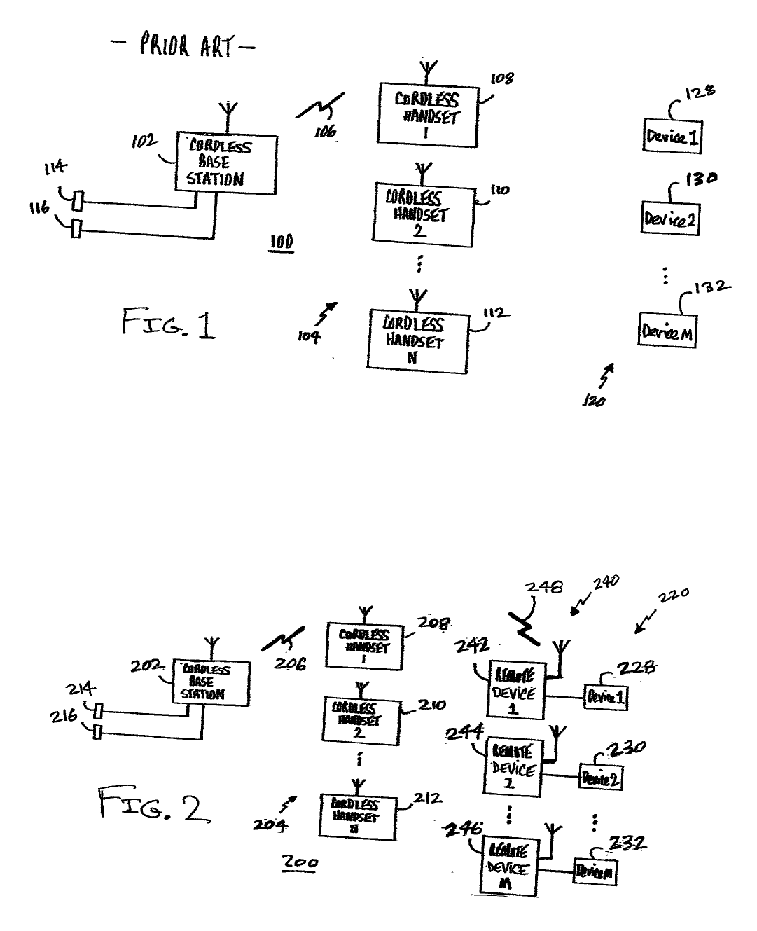

### DETAILED DESCRIPTION OF THE PREFERRED EMBODIMENTS

A remote wireless intercom and other inventive devices for communicating with a cordless telephone system are described herein. The remote wireless intercom may include a transmitter, a receiver, a speaker, a microphone, a battery interface, and a housing which carries these components. A method of communicating between the remote wireless intercom and a cordless telephone device involves the steps of detecting an intercom voice communication request at the remote wireless intercom; transmitting the intercom voice communication request from the remote wireless intercom to the a cordless telephone device; and engaging the remote wireless intercom in an intercom voice communication session with the cordless telephone device after transmitting the intercom voice communication request. A unique intercom alert is provided at the cordless telephone device when the intercom voice communication request is received.

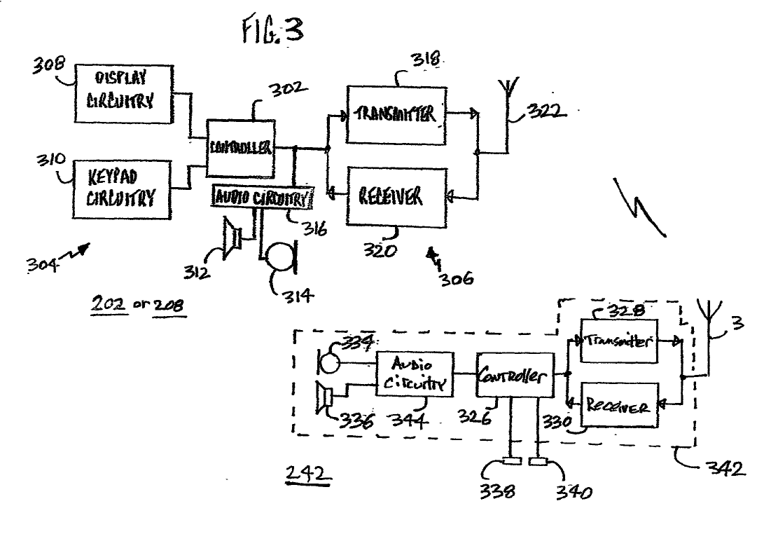

FIG. 2 is a schematic block diagram of a cordless telephone system 200 as well as a plurality of devices 220 and remote wireless devices 240. Cordless telephone system 200 includes a cordless base station 202, which may be referred to as a cordless base unit, and a plurality of cordless handsets 204, each of which may be referred to as a cordless telephone unit. The plurality of cordless handsets 204 includes cordless handsets 208-212, designated as cordless handsets 1 through N in FIG. 2.

As is conventional, cordless telephone system 200 provides for wireless telephone communications within a relatively small geographical area for an end-user. Cordless base station 202 and cordless handset 208 communicate with each other via radio frequency (RF) signals 206. Cordless base station 202 has an interface for coupling to an alternating current (AC) power source 214, such as that commonly provided in a home residence or business. Cordless base station 202 has another interface for coupling to land line 216, which couples cordless base station 202 to the public switched telephone network (PSTN) for land line telephone communication.

Cordless handset 208, which is representative of other cordless handsets 210-212, typically includes a user interface which includes a speaker, a microphone, a display, and a keypad having conventional dual-tone multiple frequency (DTMF) keys for dialing. Cordless base station 202 may or may not have the same or similar interface. Thus, cordless base station 202, cordless handset 208, or both devices can be used to make and receive telephone calls.

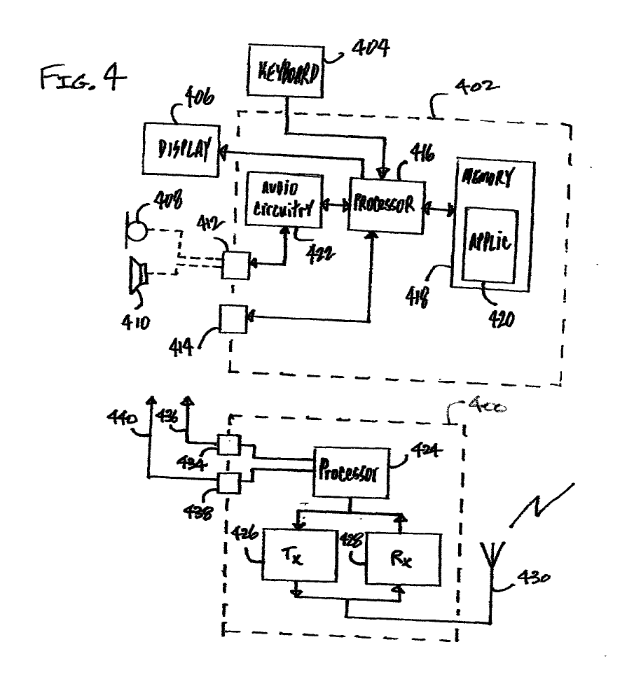

FIG. 3 is a schematic block diagram of cordless base station 202 or cordless handset 208 of FIG. 2, as well as remote wireless device 242 of FIG. 2. The schematic block diagram is illustrated for either cordless base station 202 or cordless handset 208 since similar components exist in each device. In the following description, the schematic diagram of FIG. 3 will be referred to as illustrating cordless handset 208.

As shown, cordless handset 208 of FIG. 3 includes electrical components such as a controller 302, user interface circuitry 304, and transceiver circuitry 306. User interface circuitry 304 includes display circuitry 308 for use in connection with a visual display such as a Liquid Crystal Display (LCD), keypad circuitry 310 for use in connection with a keypad, and audio circuitry 316 for use in connection with a speaker 312 and a microphone 314. Transceiver circuitry 306 includes a transmitter 318, a receiver 320, and an antenna 322. Transceiver circuitry 306 uses RF techniques for communication and, in particular, frequency modulation (FM) techniques. Preferably, transceiver circuitry 306 utilize FM techniques in the 900 MHz or 2.4 GHz Industrial, Scientific, and Medical (ISM) bands. Alternatively, transceiver circuitry 306 may utilize other well-known communication techniques, such as Time Division Multiple Access (TDMA) or Code Division Multiple Access (CDMA) communication schemes.

Basic operation of cordless handset 208 of FIG. 3 is now described. When an end-user of cordless handset 208 is engaged in a telephone call, the end-user speaks or conveys audible voice signals into microphone 314 which provides low-level analog signals to audio circuitry 316 for processing the information. This information is conveyed to transmitter 318 and transmitted through antenna 322 via RF signals to cordless base station 202 (FIG. 2). On the other hand, cordless handset 208 of FIG. 3 receives RF signals from cordless base station 202 (FIG. 2) through antenna 322 and receiver 320 which processes them and provides them to audio circuitry 316. Audio circuitry 316 processes these signals and provides them to speaker 312, which generates audible voice signals for the end-user. Controller 302 provides general control over transmitter 318, receiver 320, and audio circuitry 316 as needed.

The keypad which is used with keypad circuitry 310 typically includes conventional telephone keys (i.e., dual-tone multiple frequency or DTMF keys 0-9, *, and #) as well as control keys. The end-user initiates telephone calls by pressing the keys of the keypad, where keypad circuitry 310 uniquely detects each key that is pressed and provides this information to controller 302. Controller 302 then passes this DTMF key selection data to transmitter 318 in suitable form so that it can be transmitted from antenna 322 to cordless base station 202 (FIG. 2). In response, cordless base station 202 (FIG. 2) generates DTMF tones based on the DTMF key selection data for originating the telephone call. The keypad is used for other reasons as well, such as for changing the channel that cordless base station 202 and handset 208 use for communications.

The visual display (e.g., LCD) which is used with display circuitry 308 confirms the identification of the keys that were pressed by visually displaying them upon actuation. The visual display also displays other useful information to the end-user, such as caller identification (ID) information, the current date and time, as well as the current channel number. The caller ID information is transmitted to cordless handset 208 from cordless base station 202 (FIG. 2) when a telephone call over the PSTN is received. Controller 302 receives such data from receiver 320 and passes it in suitable form to display circuitry 308 for display.

Referring back to FIG. 2, the plurality of devices 220 include various devices 228-232, designated as devices 1 through M in the figure, which are compatible with cordless telephone system 200. The plurality of devices 220 include devices such as an intercom installed in a home residence or business, a computer such as a personal computer (PC) or laptop (with or without browser software for the Internet or WWW), an AM/FM radio (including its associated tape and CD players) and its remote controllers, a television and its remote controllers, a video camera recorder (VCR) and its remote controllers, and sensors such as temperature sensors, weather sensors, and motion detection sensors. Although devices 220 and remote wireless devices 240 are shown as separate devices in FIG. 2, they may be integrated into a single device and/or housing, as is the remote wireless intercom described later.

As apparent, the plurality of devices 220 are electrical in nature and some of them already have wireless communication capabilities. Advantageously, cordless telephone system 200 is able to communicate with them and utilize their information. Having many different devices that are compatible with each other ends the frustration of end-users who would otherwise have to utilize the interface of each device separately for its specific purpose.

Referring back to FIG. 3, a schematic block diagram of remote wireless device 242 of FIG. 2 is also shown. In this embodiment, remote wireless device 242 of FIG. 3 is configured as a remote wireless intercom. Remote wireless device 242 includes a controller 326, a transmitter 328, a receiver 330, an antenna 332, a microphone 334, a speaker 336, audio circuitry 344, and actuators 338 and 340. All of these components may be carried and included in a housing 342.

The schematic diagram of FIG. 3 is now described as illustrating cordless base station 202 (as opposed to cordless handset 208) operating in connection with remote wireless device 242. Transmitter 328 and receiver 330 of remote wireless device 242 are configured for communicating with receiver 320 and transmitter 318 of cordless base station 202, respectively. Preferably, remote wireless device 242 also has a battery interface (not shown) which is physically and electrically configured to receive battery cells for supplying power to these components. Also, microphone 334 and speaker 336 may be a combined speaker-microphone where an end-user may either only talk or listen at any one time. In an alternate embodiment, cordless base station 202 has two pairs of transceivers where one transceiver is utilized for communications with cordless handsets 204 (FIG. 2) and the other transceiver is utilized for communications with remote wireless device 242.

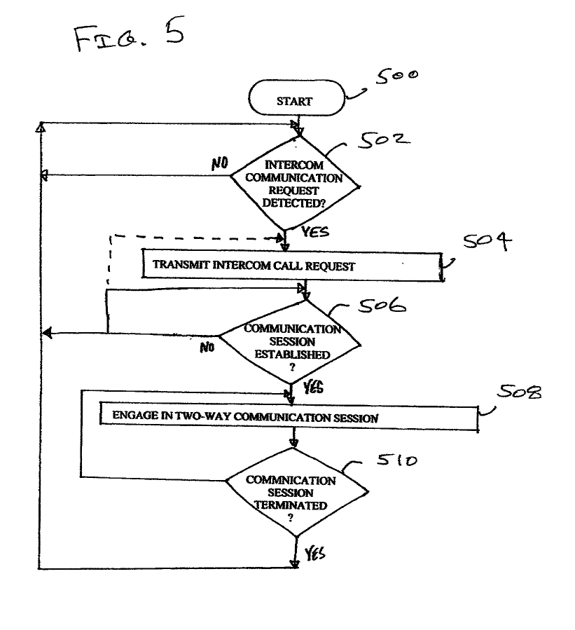

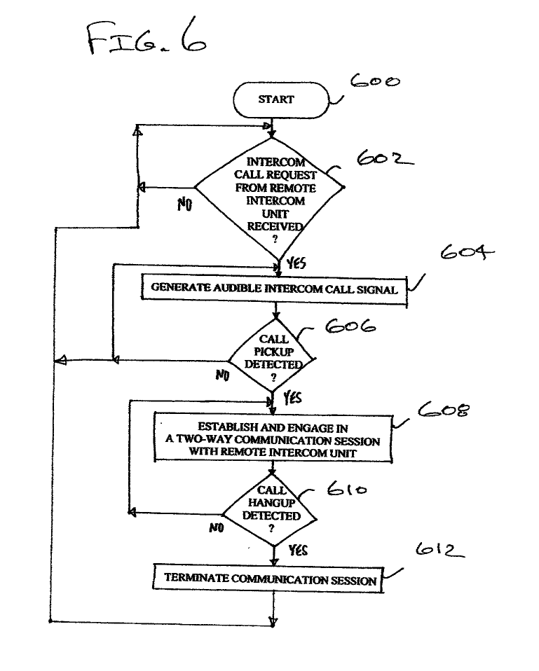

Operation of this remote wireless intercom is now described in connection with the flowcharts of FIGS. 5 and 6. FIG. 5 is a flowchart describing a method of sending information from remote wireless device 242 to cordless base station 202, whereas FIG. 6 is a flowchart describing a method of receiving information at cordless base station 202 from remote wireless device 242.

Referring to FIGS. 3 and 5 in combination, and beginning at a start block 500 of FIG. 5, remote wireless device 242 monitors one of its actuators 338 and 340 to detect any intercom communication request (step 502). This can be performed by, for example, controller 326 detecting a change in voltage by an end-user pressing actuator 338, or controller 326 detecting a change in voltage from an end-user walking sufficiently close to actuator 338 where actuator 338 is a motion detector sensor. If the intercom communication request is not detected, remote wireless device 242 keeps monitoring. In this state, remote wireless device 242 preferably operates in a low power consumption mode where little if any transmission occurs.

If the intercom communication request is detected at step 502, remote wireless device 242 wirelessly transmits an intercom call request to cordless base station 202 (step 504). This can be performed by controller 326 sending a suitable unique message to cordless base station 202 through transmitter 328 and antenna 332. After transmitting the intercom call request at step 504, remote wireless device 242 waits for a voice communication session to be established (step 506). In one embodiment, controller 326 sends the message to cordless base station 202 at step 504 only once and, if the voice communication session is not established within a predetermined time period (e.g., twenty seconds), the request is canceled and the method begins again at step 502. In another embodiment, controller 326 sends the message to cordless base station 202 at step 504 a predetermined number of times (e.g., five times) before canceling the request and going back to step 502.

If the communication session is established, remote wireless device 242 engages in a two-way voice communication session with cordless base station 202 (step 508), which may establish a communication session with its cordless handsets 204 (FIG. 2). The two-way voice communication session emulates a two-way telephone call. This session may be a full duplex two-way communication where two voice channels are established between the devices, or a half duplex two-way communication where a single voice channel is established between the devices. Remote wireless device 242 exits its low power consumption mode and begins transmitting and receiving voice information using transmitter 328 and receiver 330. This mode may be referred to as a talk mode or a high power consumption mode.

More particularly, during step 508 the end-user of remote wireless device 242 speaks or conveys audible voice signals into microphone 334, which provides low-level analog signals to audio circuitry 344 for processing the information. This information is conveyed to transmitter 328 and transmitted through antenna 332 via RF signals to cordless base station 202. Cordless base station 202 receives these RF signals through antenna 322 and receiver 320 which processes them and provides them to audio circuitry 316. Audio circuitry 316 processes these signals and provides them to speaker 312, which generates audible voice signals for the end-user of cordless base station 202. At the same time, the end-user of cordless base station 202 speaks or conveys audible voice signals into microphone 312, which provides low-level analog signals to audio circuitry 316 for processing the information. This information is conveyed to transmitter 318 and transmitted through antenna 322 via RF signals to remote wireless device 242. Remote wireless device 242 receives these RF signals through antenna 332 and receiver 330 which processes them and provides them to audio circuitry 344. Audio circuitry 344 processes these signals and provides them to speaker 336, which generates audible voice signals for the end-user of remote wireless device 242.

Remote wireless device 242 continues with the communication of voice signals while its controller 326 monitors for the termination of the session (step 510). When the session is terminated at step 510, the voice channels that were established for the intercom session are torn down and voice communication ceases. Remote wireless device 242 resumes the operation in its low power consumption mode where it does little if any transmission. The flowchart repeats starting again at step 502.

The wireless intercom method is now described from the perspective of cordless base station 202 of FIG. 3. Referring now to FIGS. 3 and 6 in combination, and beginning at a start block 600 of FIG. 6, cordless base station 202 monitors for the detection of any intercom communication request (step 602). This can be performed by, for example, controller 302 detecting a suitable unique message from remote wireless device 242 which would be received by receiver 320. If the intercom communication request is not detected, cordless base station 202 keeps monitoring. In this state, cordless base station 202 and cordless handset 208 preferably operate in a low power consumption mode where little if any transmission occurs.

If the intercom communication request is detected at step 602, cordless base station 202 generates an audible intercom alert signal from speaker 312 or other device (step 604). After receiving the intercom call request at step 604, cordless base station 202 waits for a call pickup to be detected (step 606). In one embodiment, controller 302 receives the intercom call request message from remote wireless device 242 at step 602 only once and, if a call pickup is not detected within a predetermined time period (e.g., twenty seconds), the request is canceled and the method begins again at step 602. In another embodiment, controller 302 receives the message from remote wireless device 242 at step 602 a predetermined number of times (e.g., five times) while monitoring for the call pickup before canceling the request and going back to step 602.

If and when the call pickup is detected at step 606, cordless base station 202 establishes a two-way communication session with remote wireless device 242 (step 608). As described earlier, the two-way voice communication session emulates a two-way telephone call. This session may be a full duplex two-way communication where two voice channels are established between the devices, or a half duplex two-way communication where a single voice channel is established between the devices. Cordless base station 202 exits its low power consumption mode and begins transmitting and receiving voice information using transmitter 328 and receiver 330. This mode may be referred to as the talk mode or the high power consumption mode.

Cordless base station 202 continues with the communication of voice signals while its controller 302 monitors for a call hang-up (step 610). When the hang-up is detected at step 610, the voice channels that were established for the intercom session are torn down and voice communication ceases (step 612). Cordless base station 202 resumes the operation in its low power consumption mode where it does little if any transmission. The flowchart repeats starting again at step 602.

Advantageously, a remote wireless intercom can be placed outside a home residence or business and utilized with the cordless telephone system with little if any significant installation effort. Also, an end-user of the cordless telephone system does not have to interact with a separate intercom user-interface, but rather only with his or her cordless telephone system. Although the above-described embodiment involves direct communication between a remote wireless intercom and a cordless base station, preferably indirect communications takes place between the remote wireless intercom and a cordless handset through the cordless base station using base-to-handset and handset-to-base communications. In this case, what is displayed or heard at the cordless base station is alternatively or also displayed or heard at the cordless handset(s). It is noted that other various alterations can be made to the above-described embodiments as well.

FIG. 4 is a schematic block diagram of another type of communication system which involves a remote wireless device 400, a computer 402 which connects to remote wireless device 400, and cordless telephone system 200 (FIG. 2). Computer 402 is mostly a conventional operating personal computer (PC) or laptop computer, having a keyboard 404 and a display 406. Computer 402 also has an audio interface 412 for coupling to a microphone 408 and a speaker 410, and a communication interface 414. Internally, computer 402 has a processor 416, a memory 418 which holds an application program 420 that processor 416 executes, and audio circuitry 422 coupled to audio interface 412. Application program 420 may be any suitable software program, such as a calendar/scheduling program, an electronic mail (or e-mail) program, or an audio delivery program.

Remote wireless device 400 of FIG. 4 includes a processor 424, a transmitter 426, a receiver 428, an antenna 430, a communication interface 434, and an audio interface 438. All of these components may be carried and included in a housing (not shown). Transmitter 426 and receiver 428 are configured for communicating with receiver 320 and transmitter 318, respectively, of cordless base station 202 (FIG. 3). Remote wireless device 400 may also have a battery interface (not shown) which is physically and electrically configured to receive battery cells for supplying power to its electrical components. In an alternate embodiment, cordless base station 202 (FIG. 3) has two pairs of transceivers where one transceiver is utilized for communications with its cordless base station and the other transceiver is utilized for communications with remote wireless device 400.

Communication interface 434 of remote wireless device 400 is configured for coupling with communication interface 414 of computer 402 through a cord and connector 436. Communication interface 414 of computer 402 may be, for example, a standard I/O data port (serial, parallel, USB, or other). In addition, audio interface 438 of remote wireless device 400 is configured for coupling with audio interface 412 of computer 402 through a cord and connector 440.

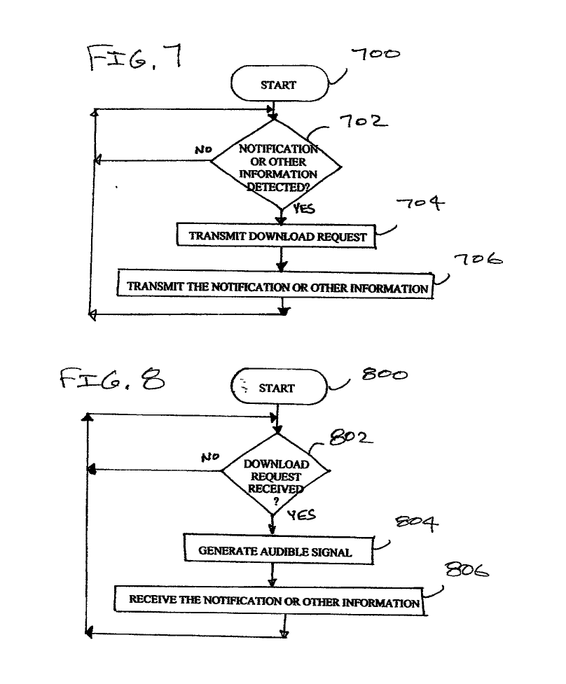

Operation of remote wireless device 400 of FIG. 4 is described in connection with the flowcharts of FIGS. 7 and 8. FIG. 7 is a flowchart describing a method of sending information from remote wireless device 400 of FIG. 4 to cordless base station 202 of FIG. 3; and FIG. 8 is a flowchart describing a method of receiving information at cordless base station 202 of FIG. 3 from remote wireless device 400 of FIG. 4.

Referring to FIGS. 4 and 7 in combination, and beginning at a start block 700 of FIG. 7, remote wireless device 400 monitors for a notification or other information from computer 402 (step 702). For example, if application program 420 is a calendar/scheduling program which includes a scheduling notification function, application program 420 will generate notification data which will be sent to communication interface 414 at a time corresponding to a scheduled event (e.g., a scheduled conference call at 10:00 A.M.) entered into the scheduling program. As another example, if application program 420 is an e-mail program which includes an e-mail notification function, application program 420 will generate notification data which will be sent to communication interface 414 upon receipt of every new e-mail message. Regardless of the specific program utilized, processor 424 monitors, detects, and receives the information through communication interface 436.

When the information is received, remote wireless device 400 sends a download request message to the cordless base station (step 704). More particularly, processor 424 detects and receives the notification information at communication interface 434 and causes a download request message to be sent via transmitter 426 and antenna 430. After sending the download request message, the notification or other information is sent from remote wireless device 400 to the cordless base station (step 706). Again, the information is received at communication interface 434 by processor 424 and is sent via transmitter 426 and antenna 430. The downloading may be invoked immediately after sending the download request message or, alternatively, after receiving an acknowledgment of the download request message from the cordless base station.

This computer information method is now described from the perspective of cordless base station 202 of FIG. 3. Referring now to FIGS. 4 and 8 in combination, and starting at a start block 800 of FIG. 8, the cordless base station receives a download request message from remote wireless device 400 (step 802). In response, the cordless base station generates an audible alert signal to be heard by the end-user (step 804). Preferably, the audible signal generated at the cordless base station in response to the message is one that is distinguishable from the audible signal heard when a telephone call or intercom call is received. In one example, the alert for a standard telephone call is a standard ring signal; the alert for an intercom call is a ring signal having a unique cadence; and the alert for the receipt of computer information is one or more “beep” signals.

Next, the notification or other information is received by the cordless base station for display in its visual display (step 806). This information may include, for example, identification of the date, time, persons, and subject matter of a corresponding scheduled event; or identification of the sending party and the subject matter of a recently received e-mail as well as the e-mail message text, which may be received upon further request by the end-user via a key press.

In an alternate embodiment, remote wireless device 400 may also be configured to send other signals, such as audio signals, to the cordless base station which are initially processed at computer 402. In the case of audio, for example, audio signals may be received from a compact disc (CD) inserted into a CD-ROM drive of computer 402 or from a remote server on the Internet. The audio signals are obtained by processor 416 of computer 402, fed to audio circuitry 422, sent to audio interface 412 and over cable 440 to audio interface 438 of remote wireless device 400, and transmitted from transmitter 426 and antenna 430. Ultimately, the audio signals are received by the cordless base station and/or cordless handset and played out of its speaker for the end-user to listen to in a similar fashion. In an alternate embodiment, remote wireless device 400 is configured to receive the audio signals from the cordless handset for recording and storage by computer 402.

As apparent, many features and data are available with remote wireless device 400 and computer 402. This includes features such as audible alerting, LCD, and/or voice reminders of appointments and scheduled events such as birthdays, meetings, and TV shows; audible altering, LCD text and graphics, and/or voice notifications of updates, outcomes, or events such as weather forecasts, stock quotes, sports scores, and email arrival; voice-over-IP telephone calls; voice-synthesized information for reviewing email or any Web text converted into voice; and handset control and selection through text, graphics, or voice menus.

Although the above-described embodiment involves direct communication between a remote wireless intercom and a cordless base station, preferably indirect communications takes place between the remote wireless intercom and a cordless handset through the cordless base station using base-to-handset and handset-to-base communications. In this case, what is displayed or heard at the cordless base station is alternatively or also displayed or heard at the cordless handset(s). It is noted that other various alterations can be made to the above-described embodiments as well.

Other types of devices may also be compatible with cordless telephone system 200 of FIG. 2. For example, remote wireless devices can be utilized with an AM/FM radio (including its associated tape and CD players) and its remote controllers, a television and its remote controllers, a VCR and its remote controllers, and sensors such as temperature sensors, weather sensors, and motion detection sensors.

When utilized with a television, VCR, or radio, the remote wireless device is configured to communicatively control the operation of such device or devices. Here, the remote wireless device may be installed within the TV, VCR, or radio, or alternatively be externally connected to the TV, VCR, or radio. Preferably, the user interface of the cordless handset utilized to control the TV, VCR, or radio is the same user interface utilized for telephone operations. The cordless handset sends, in response to user key actuations, the appropriate commands for changing channels, programming, powering on and off, muting and unmuting audio by key actuation or automatically when calls are placed or answered, etc. In this case, an infrared-to-RF converter may be utilized in the cordless telephone system to convert the infrared signals from the TV, VCR, or radio into RF signals, and an RF-to-infrared converter may also be utilized.

When utilized with a sensor, such as a temperature sensor, the remote wireless device receives temperature information from the sensor and sends this information to the cordless handset for visual display. The sending may take place periodically, or only in response to temperature changes, or only when polled by the cordless base station. Other weather sensors may be used for wind speed, wind direction, rain fall, humidity, air pressure, etc. A delivery sensor may be used which can detect when physical objects, such as mail or newspapers, have been deposited. Also, a motion detector sensor may be used in a variety of locations where alerts and status information are provided accordingly.

Cordless handset 208 of FIG. 2 may also be a “universal” device capable of operating with two or more of these different devices. Here, cordless handset 208 is capable of engaging in telephone calls, receiving intercom calls, receiving notifications and information (scheduling, e-mail, audio) from a computer, receiving the temperature and other weather parameters, and controlling the operation of a television, VCR, and radio.

Although a “centralized” system having a single cordless base station for control and communication has been described, the present invention may also utilize more than one base station having control and communication capabilities for one or more cordless handsets in a “decentralized” system. Furthermore, each cordless base station and handset may be configured such that it can accommodate and be accommodated when it is desired to expand the system. For example, an end-user may wish to obtain an additional cordless handset for his or her already-existing cordless system involving a single cordless base station and a single cordless handset. With this feature, the additional cordless handset is programmed to operate within the end-user's system where both the original and additional handsets receive the user information in accordance with the present invention.

Thus, a communication system of the present invention more generally involves a cordless telephone system including at least one cordless base station and at least one cordless telephone unit for communicating with the at least one cordless base station. The at least one cordless telephone unit has a user interface, such as a visual display or a speaker, for conveying user information to an end-user of the cordless telephone unit. Advantageously, the cordless telephone system and a remote wireless device are configured for communicating with each other. The remote wireless device includes a controller which generates or obtains the user information, and a transmitter which transmits the user information to the cordless telephone system to be conveyed at the user interface of the cordless telephone unit.

The remote wireless device may be a remote wireless intercom. Here, the remote wireless intercom may include a speaker, a microphone, a receiver, a battery interface, and a housing which carries all of these components. The user information involves voice signals, and the speaker, the microphone, the receiver, and the transmitter are used for engaging in an intercom voice communication session with the cordless telephone system. A method of communicating between the remote wireless intercom and a cordless telephone device involves the acts of detecting an intercom voice communication request at a remote wireless intercom; transmitting the intercom voice communication request from the remote wireless intercom to a cordless telephone device; and engaging the remote wireless intercom in an intercom voice communication session with the cordless telephone device after transmitting the intercom voice communication request. The act of detecting the intercom voice communication request may involve detecting a switch actuation at the remote wireless intercom, or detecting a motion sensor signal at the remote wireless intercom. The intercom communication session may involve direct communication between the remote wireless device and a cordless telephone unit, or indirectly between the remote wireless device and the cordless telephone unit through a cordless base station.

Alternatively, a remote wireless device may have a communication interface configured for coupling to a computer. In this case, the computer has an application program residing in memory which is executable to generate the user information which is sent to the remote wireless device for transmission to the cordless telephone system. The application program may be a scheduling notification program, an electronic mail notification program, or an audio delivery program. Finally, the remote wireless device may be coupled to and receive user information from other various devices, such as a sensor which is either a temperature sensor, a weather sensor, or a motion detector sensor.

Advantageously, the remote wireless devices are electrical in nature and have wireless communication capabilities, and the cordless telephone system is able to communicate with them and utilize their information. Having different devices that are compatible with each other ends the frustration of end-users who would otherwise have to utilize the interface of each device separately for each specific purpose.

It is to be understood that the above is merely a description of preferred embodiments of the invention and that various changes, alterations, and variations may be made without departing from the true spirit and scope of the invention as set for in the appended claims. None of the terms or phrases in the specification and claims has been given any special particular meaning different from the plain language meaning to those skilled in the art, and therefore the specification is not to be used to define terms in an unduly narrow sense.

What is claimed is:

1. A communication system, comprising:
a cordless telephone system including at least one cordless base station and at least one cordless telephone unit for communicating with the at least one cordless base station, the at least one cordless telephone unit having a user interface for conveying information to an end-user; and
a remote wireless device configured for communicating with the cordless telephone system, the remote wireless device including a controller which generates or obtains the user information and a transmitter which transmits the information to the cordless telephone system to be conveyed at the user interface of the cordless telephone unit.

2. The communication system according to claim 1, wherein the remote wireless device comprises a remote wireless intercom.

3. The communication system according to claim 1, wherein the remote wireless device comprises a remote wireless intercom further including:
a speaker;
a microphone;
a receiver;
a housing which carries the speaker, the microphone, the receiver, and the transmitter; and
wherein the information comprises voice signals, and the speaker, the microphone, the receiver, and the transmitter are used for engaging in an intercom voice communication session with the cordless telephone system.

4. The communication system according to claim 1, wherein the remote wireless device comprises a remote wireless intercom further including:
a speaker;
a microphone;
a receiver;
a battery interface used for supplying power to the speaker, the microphone, the receiver, and the transmitter;
a housing which carries the speaker, the microphone, the receiver, the transmitter, and the battery interface; and
wherein the information comprises voice signals, and the speaker, the microphone, the receiver, and the transmitter are used for engaging in an intercom voice communication session with the cordless telephone system.

5. The communication system according to claim 1, the remote wireless device further including:
a communication interface for coupling to and receiving the information from a computer.

6. The communication system according to claim 1, wherein the remote wireless device includes a communication interface configured for coupling to a computer, the computer having an application program residing in memory which is executable to generate the information which is sent to the remote wireless device for transmission to the cordless telephone system.

7. The communication system according to claim 1, wherein the remote wireless device is coupled to and receives the information from a sensor comprising one of a temperature sensor, a weather sensor, or a motion detector sensor.

8. A remote wireless intercom for communicating with a cordless telephone device, the remote wireless intercom comprising:
a detector which detects an intercom voice communication request; and
a wireless transceiver which transmits the intercom voice communication request to a cordless telephone device and engages in an intercom voice communication session with the cordless telephone device after transmitting the intercom voice communication request.

9. The remote wireless intercom of claim 8, wherein the detector comprises an end-user switch.

10. The remote wireless intercom of claim 8, wherein the detector comprises a motion sensor.

11. The remote wireless intercom of claim 8, further comprising:
a speaker;
a microphone;
a battery interface; and
a housing which carries the detector, the transceiver, the speaker, the microphone, and the battery interface.

12. A method of communicating between a remote wireless intercom and a cordless telephone device, the method comprising the acts of:
detecting an intercom voice communication request at a remote wireless intercom;
wirelessly transmitting the intercom voice communication request from the remote wireless intercom to a cordless telephone device; and
engaging the remote wireless intercom in an intercom voice communication session with the cordless telephone device after transmitting the intercom voice communication request.

13. The method of claim 12, wherein the act of detecting the intercom voice communication request further comprises detecting a switch actuation at the remote wireless intercom.

14. The method of claim 12, wherein the act of detecting the intercom voice communication request further comprises detecting a motion sensor signal at the remote wireless intercom.

15. The method of claim 12, wherein engaging in the intercom voice communication session further comprises sending and receiving radio frequency (RF) carrier signals modulated with voice signals.

16. The method of claim 12, wherein the act of engaging in the intercom voice communication session further comprises engaging in communication with a cordless telephone device comprising a cordless base station.

17. The method of claim 12, wherein the cordless telephone device comprises a cordless telephone unit which communicates with a cordless base station, and wherein the act of engaging in the intercom voice communication session further comprises engaging in communication with the cordless telephone unit indirectly through the cordless base station.

18. A communication system, comprising:
a cordless telephone system including at least one cordless base station and at least one cordless telephone unit for communicating with the at least one cordless base station, the at least one cordless telephone unit having a user interface including a visual display and a speaker for conveying information;
a remote wireless device configured for communicating with the cordless telephone system, the remote wireless device including:
a computer interface for coupling with and receiving the information from a computer; and
a transceiver for communicating the information to the cordless telephone system.

19. The communication system according to claim 18, wherein the transceiver of the remote wireless device is configured to communicate the information to the cordless base station of the cordless telephone system.

20. The communication system according to claim 18, wherein the computer interface receives the information from an application program residing on the computer, the application program comprising a scheduling notification program.

21. The communication system according to claim 18, wherein the computer interface receives the information from an application program residing on the computer, the application program comprising an electronic mail program.

22. The communication system according to claim 18, wherein the computer interface receives the information from an application program residing on the computer, the application program comprising an audio delivery program.
